(19) United States
(12) Patent Application Publication
(10) Pub. No.: US 2007/0268272 A1
(43) Pub. Date: Nov. 22, 2007

(54) Variable capacitor array

(75) Inventors: Haim Perski, Hod-HaSharon (IL); Avi Ezer Ben-Eliyahu, Tzur-Hadassa (IL); Nir Eilon, Tel-Aviv (IL)

Correspondence Address: Martin D. Moynihan;PRTSI, Inc., P.O. Box 16446, Arlington, VA, 22215, US

(73) Assignee: N-trig Ltd., Kfar-Saba (IL)

(21) Appl. No.: 11/798,894

(22) Filed: May 17, 2007

Related U.S. Application Data
(60) Provisional application No. 60/801,394, filed on May 19, 2006.

(51) Int. Cl. G06F 3/041

(52) U.S. Cl. 345/173; 345/174

(57) ABSTRACT

A digitizer includes a digitizer sensor comprising at least one pair of conductive lines coupled to at least one differential amplifier through which a difference signal is detected, and at least one capacitor operative to balance differences in parasitic capacitance between the conductive lines of the at least one pair of conductive lines.

### CROSS REFERENCE TO RELATED APPLICATION

The present application claims the benefit under section 35 U.S.C. §119(e) of U.S. Provisional Application No. 60/801,394 filed on May 19, 2006 which is hereby incorporated by reference.

### FIELD OF THE INVENTION

The present invention relates to digitizing tablet systems and more particularly to unbalanced capacitance in digitizing tablet systems.

### BACKGROUND OF THE INVENTION

Digitizing tablet systems that allow a user to operate a computing device with a stylus and/or fingertip are known. Typically, a digitizer is integrated with a display screen, e.g. over-laid on the display screen, to correlate user input, e.g. physical touch or stylus interaction on the screen with the virtual information portrayed on it. Position detection of the stylus and/or finger tip provides input to the computing device and is interpreted as user commands.

U.S. Pat. No. 6,690,156 entitled “Physical Object Location Apparatus and Method and a Platform using the same” assigned to N-trig Ltd, and U.S. Patent Application Publication No. 20040095333 “Transparent Digitizer” also assigned to N-Trig Ltd, both of which are hereby incorporated by reference in their entirety, describe a digitizing tablet system capable of detecting position of a user input, e.g. physical object, game pieces and/or a styluses, including an electrical circuit, either active or passive. Typically, the system includes a transparent digitizer overlaid on a Flat Panel Display (FPD). The digitizer includes a matrix of vertical and horizontal conducting lines and sensors to sense an electric signal passing through the vertical and horizontal conductive lines. Positioning the physical object at a specific location on the digitizer provokes a signal whose position of origin may be detected.

U.S. Patent Application Publication No. 20040155871 entitled “Touch Detection for a Digitizer” assigned to N-trig Ltd, which is hereby incorporated by reference in its entirety, describes a digitizing tablet system capable of detecting position of both physical objects and finger touch using the same sensing conductive lines. Typically, the system includes a transparent sensor overlaid on a Flat Panel Display (FPD). The digitizer's sensor includes a matrix of vertical and horizontal conducting lines to sense an electric signal passing through the vertical and horizontal conductive lines. Touching the digitizer in a specific location provokes a signal whose position of origin may be detected.

Parasitic capacitance developed between the display screen and the conductive lines of the overlaying digitizer sensor, typically induces a current leakage into the conductive lines of the digitizer referred to as a “steady noise” and/or steady state noise. In an ideal environment, the parasitic capacitance and therefore the steady state noise level in each of the lines are expected to be identical.

Some known systems use differential amplifiers to eliminate noise that is typically introduced on the conductive lines of the digitizer sensor. If the parasitic capacitance on each of the lines where identical, the noise can be practically eliminated using a differential amplifier. However, in practice slight differences in distance between the digitizer and screen, material structure in specific areas of the digitizer screen, environmental conditions and parasitic capacitance on associated PCB, may affect the parasitic capacitance level between the screen and some of the lines. The unbalanced capacitance creates an unbalance steady state noise level of the lines. The result is a different steady state noise on each of the lines that will result in an amplified non-zero steady state signal being produced by the differential amplifier. The presence of these steady state noises may reduce the level of accuracy possible in detecting, for example, a user's finger's location.

Incorporated U.S. Patent Application Publication No. 20040155871 additionally describes a mapping solution that may be used to compensate for the display panel steady state noise phenomenon. During an initialization procedure, magnitude and phase of the difference signals for each pair of conducting lines connected to a differential amplifier is detected and stored. Once the differential map is stored in memory, it can be used to compensate for the display panel signal steady state noise phenomenon. Noise in the signal may cause saturation when sampling the signal that cannot be compensated for with the mapping solution.

### SUMMARY OF THE INVENTION

An aspect of some embodiments of the invention is the provision of a digitizer including a capacitor array to compensate for unbalanced capacitance developed between the conductive lines of a digitizer sensor and surrounding electronic components. According to some embodiments of the present invention, compensation is provided for unbalanced capacitance developed between the conductive lines of the digitizer sensor and an electronic display over which the digitizer is positioned.

According to some embodiments of the present invention, the capacitor array is operative to be coupled to one or more conductive lines of a digitizer sensor. Optionally, compensation is provided for pairs of the conductive lines operative to produce a difference signals. Optionally, the pairs of conductive lines are associated with a differential amplifier. According to some embodiments of the invention, capacitors of the capacitor array are set at values operative to compensate for or balance unbalanced capacitance between pairs of conductive lines coupled to differential amplifiers.

According to some embodiments of the invention, the capacitor array includes one or more variable capacitors coupled with one or more conductive lines of the digitizer sensor. According to some embodiments of the invention, the capacitor array additionally includes one or more fixed capacitors coupled with one or more conductive lines of the digitizer.

According to some embodiments of the present invention, the variable capacitor includes a group of capacitors connected in parallel, each capacitor in the group associated with a switch, the group being coupled with one or more conductive lines of the digitizer sensor. The number and values of capacitors in the group coupled with its corresponding switch to a conductive line determines the total capacitance introduced into the conductive line. Optionally, the capacitor values in the series may be arranged such that each capacitor has twice the capacitance of the next largest capacitor in the series. This enables provision of capacitance values between the lowest value in the group and the sum of all the values in the group with a resolution of the value of the lowest capacitance in the group.

Optionally the switches are MOSFET transistors. Optionally the switches are controlled by input signals selected by software.

According to some embodiments of the present invention, the variable capacitor array includes one or more capacitors coupled to one or more sets of conductive lines that are input to a differential amplifier via one or more switches. According to some embodiments of the present invention, the one or more capacitors are operative to compensate for unbalanced capacitance between the two lines input to the differential amplifier and are set to introduce a compensating capacitance to one of the two lines through the switches. The switches provide capability to select the conductive line to which the capacitor, e.g. variable and/or fixed is added. Optionally the switches are MOSFET transistors. Optionally the switches are controlled by input signals selected by software.

An aspect of some embodiments of the invention is the provision of a method to compensate for unbalanced capacitance in a digitizer sensor developed between the conductive lines of a digitizer sensor and surrounding electronic components. According to some embodiments of the present invention, compensation is provided for unbalanced capacitance developed between the conductive lines of the digitizer and an electronic display over which the digitizer is positioned.

According to some embodiments of the present invention, during an initialization procedure and/or manufacturing procedure a signal is introduced through one or more conductive lines and the differential outputs of pairs of lines are detected. A measured differential output is used to estimate variance in the steady state noise, introduced into the digitizer due to unbalanced capacitance. A suitable capacitor (and/or a suitable capacitance level) to be coupled to one or more of the conductive lines is selected to compensate for the detected steady state noise variance. Typically, the pairs of conductive lines are coupled by a differential amplifier. Optionally, the signal introduced through one or more conductive lines is an AC signal. Optionally, the detected steady state noise variance and/or the corresponding selected compensating capacitance are saved.

An aspect of some embodiments of the invention is to provide a digitizer comprising a digitizer sensor comprising at least one pair of conductive lines coupled to at least one differential amplifier through which a difference signal is detected, and at least one capacitor operative to balance differences in parasitic capacitance between the conductive lines of the pairs.

Optionally, the at least one capacitor is coupled to at least one conductive line of the pair.

Optionally, a capacitor is coupled to each conductive line of the pair.

Optionally, a capacitor is coupled to the at least one conductive line through a switch.

Optionally, the switch is a MOSFET switch.

Optionally, the at least one capacitor is a variable capacitor.

Optionally, the at least one capacitor has a capacitance level between 0-3.2 pF.

Optionally, the at least one capacitor includes a group of capacitors connected in parallel, each capacitor in the group associated with a switch.

Optionally, capacitors in the group of capacitors have a capacitance value double that of one other capacitor in the group.

Optionally, the switch is a MOSFET switch.

Optionally, the digitizer comprises a fixed capacitor coupled to at least one conductive line of the pair.

Optionally, the at least one pair of conductive lines are parallel to each other.

Optionally, the at least one pair of conductive lines are distanced by at least the effective range of a user input signal.

Optionally, the digitizer comprises multiple pairs of conductive lines arranged in a matrix of vertical and horizontal conductive lines.

Optionally, an object placed over one of the conductive lines of the pair produces an output on a differential amplifier.

Optionally, the digitizer comprises circuitry operative to adjust the capacitance level of the at least one capacitor.

Optionally, the at least one capacitor has a capacitance operative to increase the common mode rejection ratio of the at least one differential amplifier.

Optionally, the digitizer comprises circuitry operative to detect and sample the difference signal.

Optionally, the digitizer comprises circuitry operative to filter the difference signal.

Optionally, the capacitor has a capacitance operative to decrease a steady-state noise in the difference signal.

Optionally, the digitizer comprises one or more ASICs wherein the one or more ASICs comprising the at least one capacitor, the at least one differential amplifier.

Optionally, the ASIC is operative to adjust the capacitance level of the at least one capacitor.

Optionally, the ASIC is operative to receive capacitance level from a digital unit.

An aspect of some embodiments of the invention provides a method for reducing the effects of unbalanced parasitic capacitance in a digitizer comprising detecting a difference signal between a pair of conductive lines of a digitizer sensor, and coupling a capacitor to at least one conductive line of the pair of conductive lines to reduce the imbalance.

Optionally, the difference signal is detected while no object is placed over the digitizer sensor.

Optionally, the difference signal is obtained from unbalanced capacitance on the pair of conductive lines.

Optionally, the difference signal is obtained from unbalanced circuitry of the digitizer.

Optionally, the capacitor is coupled to each conductive line of the pair.

Optionally, the capacitor is coupled to the at least one conductive line through a switch.

Optionally, the switch is a MOSFET switch.

Optionally, the capacitor is a variable capacitor.

Optionally, the capacitor has a capacitance level between 0-3.2 pF.

Optionally, the capacitor includes a group of capacitors, each capacitor in the group associated with a switch.

Optionally, the capacitor includes a group of capacitors, each capacitor connected in parallel, each capacitor in the group associated with a switch

Optionally, the switch is a MOSFET switch.

Optionally, the method comprises controlling the switch to obtain a desired capacitance level.

Optionally, the method comprises coupling a fixed capacitor to at least one conductive line of the pair.

Optionally, the method comprises inducing an AC signal onto the pair of conductive lines.

Optionally, the method comprises adjusting the capacitance level to a value that corresponds to difference signal below a defined threshold.

Optionally, the method comprises detecting the difference signals for a range of capacitance levels coupled on the at least one conductive line, and selecting a capacitance level from the range of capacitance levels that yields a minimum difference signal.

Optionally, the capacitor is integrated into an ASIC.

Optionally, the ASIC is operative to adjust the capacitance level of the capacitor.

Optionally, a differential amplifier is operative to detect the difference signal.

Optionally, the capacitor has a capacitance operative to increase the common mode rejection ratio of the differential amplifier.

Optionally, the method comprises filtering and sampling the difference signal.

An aspect of some embodiments of the invention provides a method operating a sensor comprising at least one array of conductive lines spaced apart in a given direction and a plurality of differential amplifiers to which said conductive lines are pairwise coupled, the method including adding a capacitance to at least one line of each pair operative to compensate for imbalance capacitance, electrifying each line of a given pair with a same voltage, and determining whether a touch occurs near a conductor from an output voltage of said amplifier.

Optionally, the imbalanced is operative to balance differences in parasitic capacitance between the conductive lines of the pairs.

Optionally, the capacitance are selected using the method according to claim 24.

Optionally, the method comprises a second array of conductive lines spaced apart in a given direction, the second array perpendicular to the given array.

Optionally, the pairwise coupled conductive lines are parallel lines.

Optionally, the pairwise coupled conductive lines are spaced apart at a distance greater than the width of a finger.

An aspect of some embodiments of the invention provides a digitizer comprising a digitizer sensor comprising at least one pair of conductive lines coupled to at least one differential amplifier through which a difference signal is detected, and at least one capacitor operative to minimize the output signal of the differential amplifier when no object is present over the digitizer sensor.

### BRIEF DESCRIPTION OF THE DRAWINGS

The subject matter regarded is particularly and distinctly claimed in the concluding portion of the specification. Non-limiting examples of embodiments of the present invention are described below with reference to figures attached hereto, which are listed following this paragraph. In the figures, identical structures, elements or parts that appear in more than one figure are generally labeled with a same symbol in all the figures in which they appear. Dimensions of components and features shown in the figures are chosen for convenience and clarity of presentation and are not necessarily shown to scale. For example, the dimensions of some of the elements may be exaggerated relative to other elements for clarity.

FIG. 1 is a simplified block diagram of a digitizer system according to an exemplary embodiment of the present invention;

FIG. 2 is an exemplary circuit diagram describing touch detection;

FIG. 3 is an exemplary circuit diagram of two conductive lines of a digitizer that are input to a differential amplifier according to some embodiments of the present invention;

FIG. 4 is an exemplary representation of a variable capacitor according to embodiment of the present invention;

FIGS. 5A and 5B are circuit diagram including a variable capacitor coupled to a pair of conductive lines via switches according to some embodiments of the present invention;

FIG. 6 is an exemplary flow chart describing a method for compensating for unbalanced parasitic capacitances coupled in pairs of conductive lines coupled to an input of a differential amplifier according to some embodiments of the present invention; and

FIG. 7 is an exemplary flow chart describing another method for compensating for unbalanced parasitic capacitances coupled in pairs of conductive lines coupled to an input of a differential amplifier according to some embodiments of the present invention.

It will be appreciated that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF EXEMPLARY EMBODIMENTS

In the following description, exemplary, non-limiting embodiments of the invention incorporating various aspects of the present invention are described. For purposes of explanation, specific configurations and details are set forth in order to provide a thorough understanding of the embodiments. However, it will also be apparent to one skilled in the art that the present invention may be practiced without the specific details presented herein. Furthermore, well-known features may be omitted or simplified in order not to obscure the present invention. Features shown in one embodiment may be combined with features shown in other embodiments. Such features are not repeated for clarity of presentation. Furthermore, some unessential features are described in some embodiments.

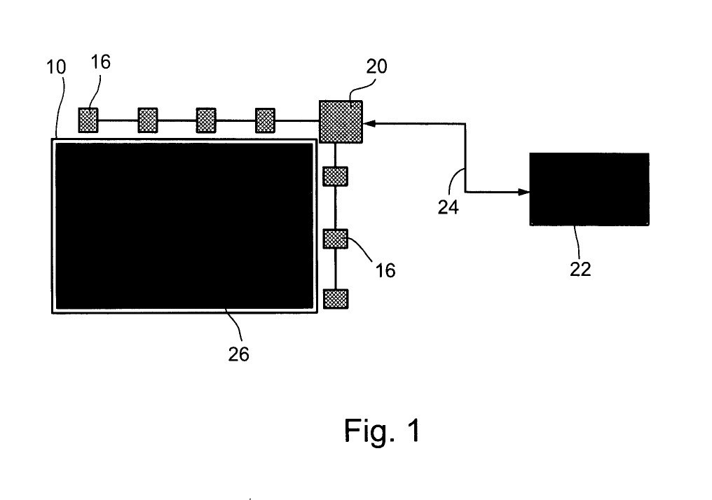

Reference is now made to FIG. 1 showing an exemplary simplified block diagram of a digitizer system in accordance with some embodiments of the present invention. The digitizer system displayed in FIG. 1 may be suitable for any computing device that enables interactions between a user and the device, e.g. mobile computing devices that include, for example, FPD screens. Examples of such devices include—Tablet PCs, pen enabled lap-top computers, PDAs or any hand held devices such as palm pilots and mobile phones. According to some embodiments of the present invention, the digitizer system comprises a grid-based sensor 12, which is optionally transparent, and which is typically overlaid of an FPD 10. An ASIC 16 comprises circuitry to process and sample the output into a digital representation. Typically ASIC 16 includes both analog and digital components. According to some embodiments of the present invention, the digital output signal is forwarded a digital unit 20, e.g. digital ASIC unit, for further digital processing. The outcome of the digital processing performed by digital unit 20 is typically the position of the user input, e.g. stylus and/or finger tip, and the outcome, once determined, is forwarded to host 22 via interface 24 for processing by the operating system or any current application.

According to some embodiments of the present invention, sensor 12 is a grid of conductive lines made of conductive materials, optionally Indium Tin Oxide (ITO), patterned on a foil or glass substrate. The conductive lines and the foil are optionally transparent. Typically, the grid is made of two layers, which are electrically separated from each other. Typically, one of the layers contains a set of equally spaced parallel conductors and the other layer contains a set of equally spaced parallel conductors orthogonal to the set of the first layer. Typically, the parallel conductors are equally spaced straight lines, and are the input to differential amplifiers in ASIC unit 16.

According to some embodiments of the present invention, ASIC unit 16 and digital unit 20 are typically mounted on the frame of sensor 12. Typically, the ASIC unit is connected to outputs of the various conductors in the grid and functions to process the received signals at a first processing stage. As indicated above, ASIC unit 16 includes an array of differential amplifiers to amplify the sensor's signals. Additionally, ASIC unit 16 includes one or more filters to remove irrelevant frequencies, for example filtered prior to sampling. The signal is then sampled by an A/D, filtered by a digital filter and forwarded to digital ASIC unit, for further digital processing.

According to some embodiments of the present invention, ASIC unit 16 additionally includes, one or more capacitors coupled to one or more conductive lines of sensor 12 to compensate for unbalanced capacitance developed between the sensor 12 and FPD 10. Typically, the one or more capacitors and/or the capacitor array is integrated into ASIC 16.

According to some embodiments of the invention, digital unit 20 reads the sampled data, processes it and determines the position of the physical objects, such as stylus, and/or finger touch. Calculated position is sent to the host computer via interface 24. According to some embodiments, digital unit 20 is to produce and manage a triggering pulse to be provided to excitation coil 26 that surrounds the sensor arrangement and the display screen. The excitation coil provides a trigger pulse that excites passive circuitry in the stylus to produce a response from the stylus that can subsequently be detected. According to some embodiments, digital unit 20 is to produce and manage a triggering pulse to at least one of the conductive line.

Stylus Detection

According to some embodiments of the present invention a stylus is a passive element. Optionally, the stylus comprises a resonant circuit, which is triggered by excitation coil 26 to oscillate at its resonant frequency. Optionally, stylus may include an energy pick-up unit and an oscillator circuit. At the resonant frequency the circuit produces oscillations that continue after the end of the excitation pulse and steadily decay. The decaying oscillations induce a voltage in nearby conductive lines which are sensed by the sensor 12. According to some embodiments of the present invention, two parallel sensor lines that are close but not adjacent to one another are connected to the positive and negative input of a differential amplifier respectively. The amplifier is thus able to generate an output signal which is an amplification of the difference between the two sensor line signals. An amplifier having a stylus on one of its two sensor lines will produce a relatively high amplitude output.

A major advantage of such a differential based scheme is its inherent noise reduction. Ideally, if the two lines in the pair are placed relatively close to each other, then both lines probably sense the same parasitic noise and other effects, and the differential amplifier, which subtracts its inputs, thus eliminates any such noise. It is noted that the two input lines which are chosen for connection to the same amplifier are preferably not placed too close to each other, otherwise, a real input signal, such as the stylus signal, is likely to be sensed by both lines and removed by the differential amplifier. Therefore, in a preferred topology, the physical distance between lines connected to the same differential amplifier is slightly larger than the effective range of the stylus transmission. The digital processing unit is subsequently able to use the phase of the sampled signal to determine which of the two inputs of the amplifier have actually received the signal.

Fingertip Touch Detection

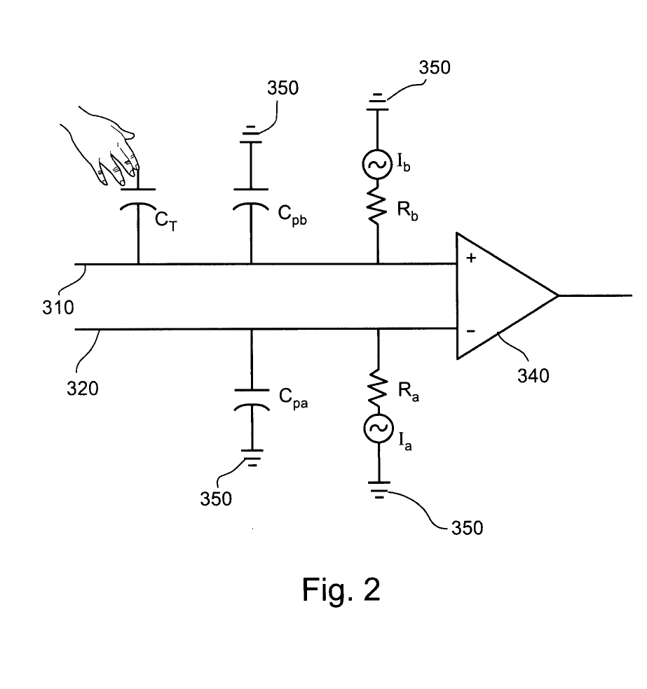

Reference is now made to FIG. 2 describing an exemplary circuit diagram for touch detection. According to some embodiments of the present invention, the pairs of lines are interrogated to determine if there is a finger. This interrogation can be serial (only one pair at a time is queried) or concurrent (a plurality or all the pairs are queried together). In an embodiment of the invention to query the pair, one or more signal sources, e.g. an AC signal source Iₐ and I_{b} (connected to conductive lines 320 and 310 via resistances and/or impedances R_{b} and Rₐ respectfully), induces an oscillating signal in conductive lines 320 and 310 of sensor 12. All signals are referenced to a common ground 350. When a finger is placed on a sensor's conductive line, say conductive line 310, a capacitance C_{T} develops between the finger and the conductor. As there is a potential between conductor 310 and the user's finger, current passes from conductor 310 through the finger to ground. Consequently a potential difference is created between conductor 310 and it paired conductor 320, both of which serve as input to differential amplifier 340.

The separation between the two conductors 310 and 320 is typically greater than the width of the finger so that the necessary potential difference can be formed. Typically, parasitic capacitance Cpb and Cpa are also present on lines 310 and 320 due to the presence of surrounding electronic components, e.g. the display screen (for example, caused by different distances of the lines from the screen). The differential amplifier 340 amplifies the potential difference developed between conductive lines 310 and 320 and ASIC 16 and digital unit 20 processes the amplified signal and thereby determines the location of the user's finger. According to some embodiments, digital processing unit 20 is operative to control an AC signal provided to conductive lines of sensor 12, e.g. conductive lines 310 and 320.

The present invention is not limited to the technical description of the digitizer system described herein. Digitizer systems used to detect stylus and/or finger tip location may be, for example, similar to digitizer systems described in incorporated U.S. Pat. No. 6,690,156, U.S. Patent Application Publication No. 20040095333 and/or U.S. Patent Application Publication No. 20040155871. It will also be applicable to other digitized systems known in the art, depending on their construction.

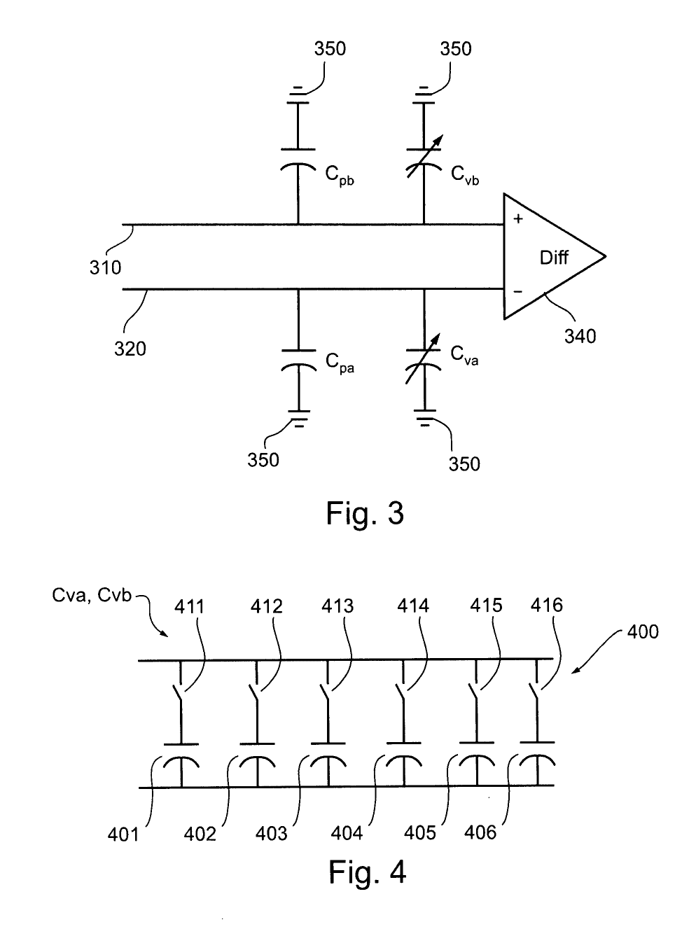

Reference is now made to FIG. 3 showing an exemplary circuit diagram of two conductive lines 310 and 320 of sensor 12 that are input to a differential amplifier 340 according to some embodiments of the present invention. Typically sensor 12 is associated with a screen 10 over which the sensor 12 is laid. Typically, differences between the parasitic capacitances Cpa and Cpb on conductors 310 and 320 of sensor 12 and screen 10 as described above. Ideally, differential amplifier 340 is operative to cancel steady state noise introduced into conductive lines 310 and 320 due to parasitic capacitances that develop on the conductive lines. However, due to imperfections in manufacturing and assembly of the digitizer and/or screen as is described herein capacitances Cpb and Cpa are not identical and therefore variation in the steady state noise on conductive lines 310 and 320 develop. These differences are typically amplified by differential amplifier 340.

According to some embodiments of the present, capacitors Cᵥₐ and C_{vb} are added to antenna's lines 320 and 310 to balance the unbalanced capacitance developed on the conductive lines by the parasitic capacitance. According to one embodiment of the present invention, capacitors Cᵥₐ and C_{vb} are set so that (Cᵥₐ+Cₚₐ) approximately equals (C_{vb}+Cₚᵥ). Optionally, Cᵥₐ and C_{vb} are experimentally set, during calibration of the system, to a value that minimizes the output from differential amplifier 340 when identical signals are introduced through conductive lines 310 and 320. Optionally, only one variable capacitor is added to one of the lines, namely the line with the lower stray capacitance. For example Cᵥₐ may be added to line 320 so that (Cₚₐ+Cᵥₐ) approximately equals C_{pb}. Optionally, only Cᵥₐ may be added to line 320 and adjusted to reduce and/or minimize the steady state noise output of differential amplifier 340. For example, capacitors Cᵥₐ and/or C_{vb} may be adjusted so as to maximize and/or increase the Common Mode Rejection Ratio (CMRR) of the differential amplifier 340.

According to some embodiments of the present invention, variable capacitors Cᵥₐ and C_{vb} varies between a defined minimum capacitance level, Cₘᵢₙ in steps of ΔC up to a maximum defined capacitance level Cₘₐₓ. In an exemplary embodiment when the values of the parasitic capacitance of the system can be pre-estimated, Cₘᵢₙ and Cₘₐₓ may be chosen to be in the range of the parasitic capacitance. According to one exemplary embodiment, Cₘᵢₙ=0, ΔC=0.05 pF and Cₘₐₓ=3.2 pF. Other capacitance levels may be implemented, depending on the actual values of stray capacitance present in the system, and the invention is not limited to these specified numbers.

According to some embodiments of the present invention, one or more variable capacitors included in ASIC unit 16 are coupled to one or more conductive lines of sensor 12. According to some embodiments of the present invention, one or more registers in the ASIC unit are dedicated to store the capacitance values of the two conductive lines of each differential amplifier. Optionally, two registers are used per differential amplifier to record capacitance of each conductive line.

According to some embodiments of the present invention digital unit 20 is operative to determine desired capacitance level on each of the conductive lines of the digitizer sensor, for example, to minimize the steady state noise amplified by the differential amplifiers. ASIC 16 is operative to adjust the capacitance level of one or more of the variable capacitors and/or record the desired capacitance level based on commands received from digital unit 20.

Reference is now made to FIG. 4 which shows an exemplary representation of a variable capacitor according to embodiment of the present invention. According to some embodiments of the present invention, variable capacitor 400 is a group of capacitors that includes one or more capacitors 401-406 connected in parallel. Each of capacitors 401-406 may be connected by respective switches 411-416 to a conductive line, e.g. conductive line 310 or conductive line 320 of digitizer sensor 12. Optionally, the switches are MOSFET transistors. According to some embodiments of the present invention, variable capacitor 400 is connected to each line of digitizer sensor 12.

The number of connected capacitors determines the total capacitance value added so that:

$${C}_{va} , {C}_{vb} = {\sum }_{i}^{N} {C}_{i}$$

Where N is the number of capacitors connected.

In an exemplary embodiment each capacitor has a capacitance value double that of the capacitor to its left on the figure. For example, capacitors 401-406 may have capacitance values of (0.05 pF, 0.1 pF, 0.2 pF, 0.4 pF, 0.8 pF, 1.6 pF) respectively. In other exemplary embodiments capacitors 401-406 may all have identical capacitance values, may have incrementally increasing capacitance, and/or a different arrangement of values. Capacitor group 400 may include any number of capacitors, e.g. 2-20 capacitors. The present invention is not limited to the mentioned capacitance values and the number of capacitors.

The present invention is not limited to the described embodiment of the variable capacitors (Cᵥₐ) and (C_{vb}).

The total capacitance of conductive line 320 is: C₃₂₀₋ₜₒₜₐₗ=Cᵥₐ+Cₚₐ, and the total capacitance of conductive line 310 is: C₃₁₀₋ₜₒₜₐₗ=C_{vb}+C_{pb}. A balanced capacitance is achieved by adjusting added capacitance Cᵥₐ and C_{vb} so that C₃₂₀₋ₜₒₜₐₗ=C₃₁₀₋ₜₒₜₐₗ. Once, the total capacitance is identical in the two lines and no object is placed on the sensor, the detected signal at the differential amplifier's output is minimal. If a perfect matching is achieved, the detected signal at the differential amplifier's output is zero.

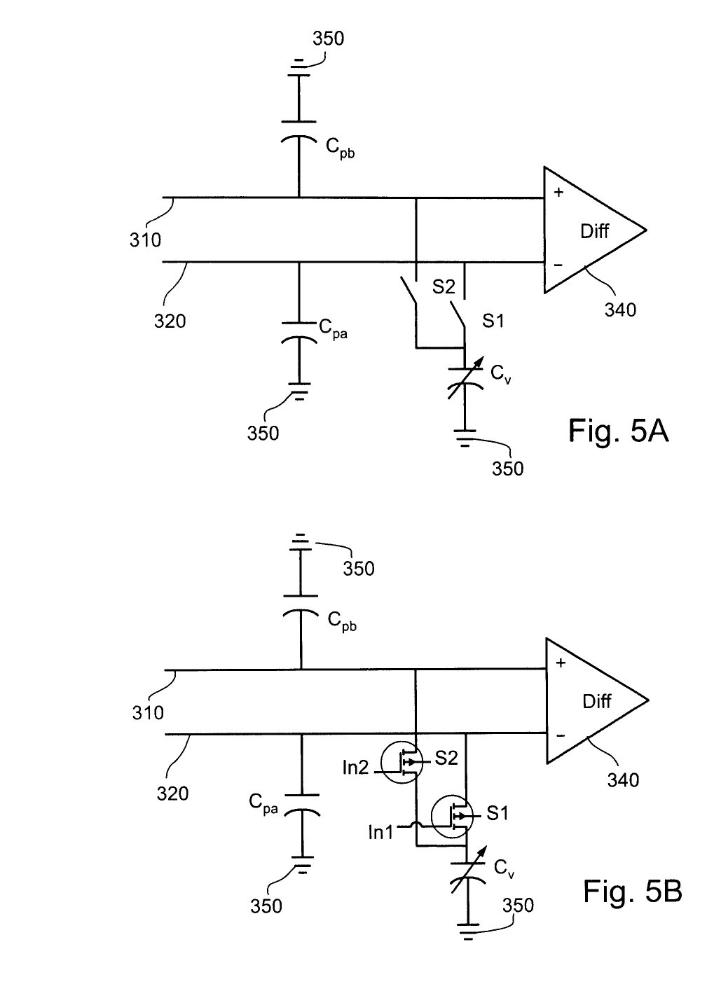

Reference is now made to FIG. 5A showing a variable capacitor Cv coupled to a pair of conductive lines via switches according to an embodiment of the present invention. According to some embodiments of the present invention a variable capacitor Cᵥ is connected to sensor conductive line 320 by switch S1 and to sensor conductor 310 by switch S2. Optionally, a fixed capacitor is added to one of the pair of conductive lines to offset the capacitance on that line and a variable capacitance is coupled to other conductive line. Optionally, the switches S1 and S2 are MOSFET transistors as illustrated in FIG. 5B. According to some embodiments of the invention, the switches enable the digitizer system to select the conductor from the pair of conductors 310 and 320 to which the capacitor is added. In an exemplary embodiment the switches are controlled by an input signal (In1) (In2) which is selected by software and/or firmware operated on digital unit 20.

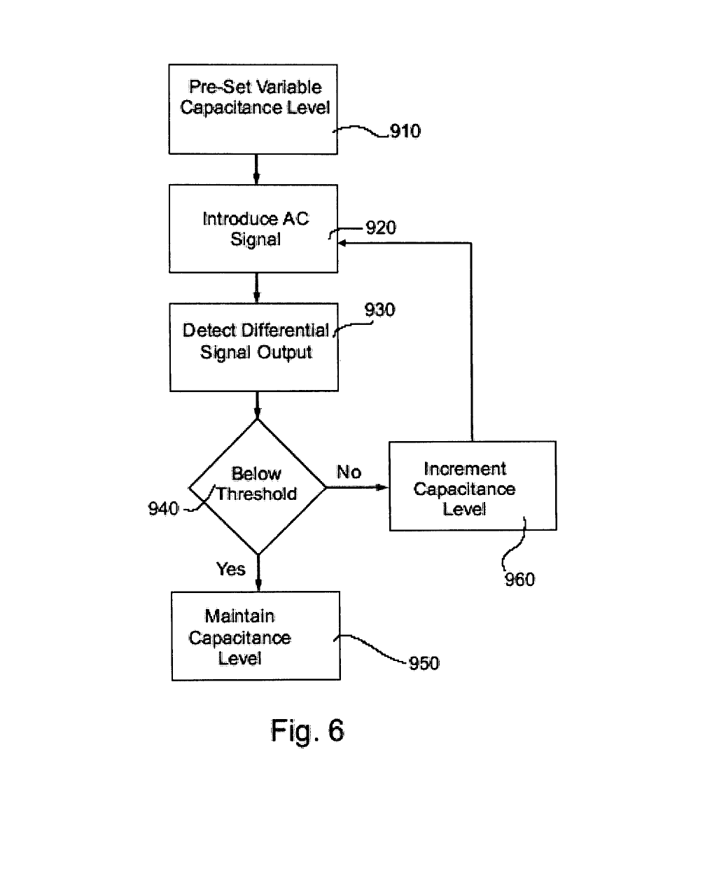

Reference is now made to FIG. 6 showing an exemplary flow chart describing a method for compensating for unbalanced parasitic capacitances in pairs of conductive lines coupled to an input of a differential amplifier according to some embodiments of the present invention. According to some embodiments of the present invention, upon start up, the value of the variable capacitor in the register is set (block 910), e.g. set to zero. Optionally, the value of the variable capacitor is set as the value obtained in previous calibration and/or as initial pre-defined value. Optionally, for a variable capacitor coupled to each conductive line of the pair, both variable capacitors are set to a pre-set value, e.g. the same pre-set value. An AC signal is introduced to each conductive line associated with a single differential amplifier (920). Optionally, an AC signal is introduced to all conductive lines of sensor 12. Output at each differential amplifier is measured (930). Typically, the output is measured in the absence of user input so that their output reflects the steady state noise in the signal. Measured values are compared to a pre-defined threshold, e.g. a minimum acceptable amplified steady state noise (block 940). For values below the threshold, the capacitance value is saved and the capacitance level is maintained (block 950). For output signals above the threshold, the added capacitance level is modified, for example modified in an incremental fashion, by a pre-defined capacitance level of Δc (block 960). Optionally, the capacitance level is first incremented on one line of the pair while the capacitance level on the other line of the pair is maintained on a constant level. Subsequently, the capacitance level incremented on the other line of the pair while the capacitance level on the first line of the pair is maintained on a constant level.

According to some embodiments of the present invention, number of iteration is limited to the value of Cₘₐₓ. Number of iteration is determined by:

$${N}_{iterations} = \frac{( {C}_{max} - {C}_{min} )}{Δ C} .$$

When minimum is detected at the output of the differential amplifiers, the capacitance value is saved at the register.

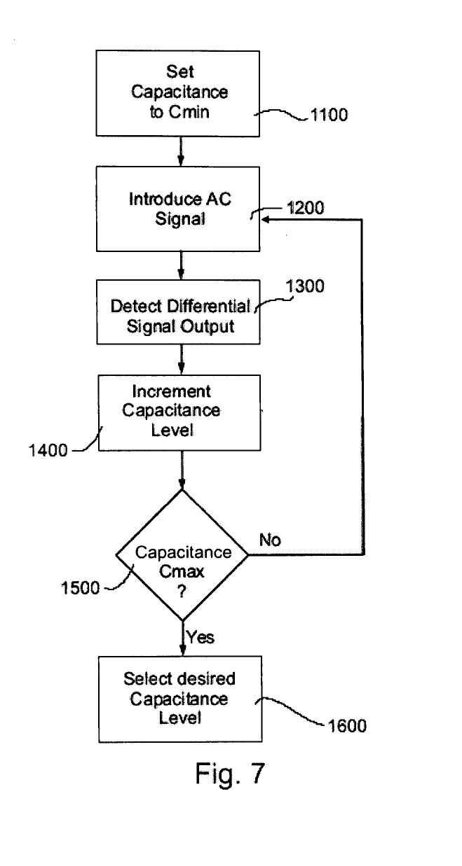

Reference is now made to FIG. 7 showing an exemplary flow chart describing another method for compensating for unbalanced parasitic capacitances coupled in pairs of conductive lines coupled to an input of a differential amplifier according to embodiments of the present invention. According to some embodiments of the present invention, upon start up, the value of the variable capacitor in the register is set to Cₘᵢₙ (block 1100). According to some embodiments of the present invention, Cₘᵢₙ=0. Optionally, Cₘᵢₙ is set at a relatively small capacitance level, e.g. 0.05 pF. Optionally, Cₘᵢₙ is set as the value obtained in previous calibration and/or as initial pre-defined value. An AC signal is introduced to each conductive lines associated with a single differential amplifier (1200). Optionally, an AC signal is introduced to all conductive lines of sensor 12. Output at each differential amplifier is measured (1300) and stored. Typically, the output is measured in the absence of user input so that their output reflects the steady state noise in the signal. The capacitance level is incremented by pre-defined incremental steps Δc (block 1400) and the difference signals output after each increment is detected. When a pre-defined maximum capacitance level Cₘₐₓ is reached (block 1500) a desired capacitance level from the range of capacitance levels tested is selected (block 1600) and, for example saved. Typically, selection is based on the capacitance level that yielded the lowest differential output. In an exemplary embodiment, a register is initially records the value of Cₘᵢₙ. As the capacitance level is incremented from Cₘᵢₙ to Cₘₐₓ the register may be updated to record a capacitance level yielding the lowest differential output. The register may be updated for subsequent incremental values of capacitance level until Cₘₐₓ is reached. The final value of register thus represents the capacitance level yielding the lowest differential output. Optionally, the capacitance level is first incremented on one line of the pair while the capacitance level on the other line of the pair is maintained on a constant level. Subsequently, the capacitance level incremented on the other line of the pair while the capacitance level on the first line of the pair is maintained on a constant level. For example, all the different combinations of capacitance level as well as to which conductive line of the pair the variable capacitor is to be coupled are tested. The outcome includes the selected capacitance level and the selected conductive line.

According to some embodiments of the present invention, the methods described herein is performed for every pair of conductive lines through which a difference signals is detected, so that a capacitor array is defined incorporating capacitors for substantially all the conductive lines (or one line of each pair) and/or the entire digitizer sensor. Typically the capacitors in the capacitor array include variable capacitors that can be adjusted during operation of the digitizer system.

This process is performed upon each start up of the system. Optionally, the process is performed several times again. Optionally, the process is performed once when the system is manufactured.

Optionally, the capacitor array includes one or more fixed capacitors. For example, a fixed capacitor possessing a capacitance level significantly greater than the parasitic capacitance level of one or more conductive lines is used to make the variation in the parasitic capacitance level substantially negligible.

According to some embodiments of the present invention, a mapping solution described above is implemented. For example, after a capacitance level is defined for each pair of conductive lines of the digitizer sensor, mapping may further reduce the steady state noise amplification of the system. According to some embodiments of the present invention, the mapping is performed upon each start up of the system. Typically, the mapping is performed during manufacturing.

It should be further understood that the individual features described hereinabove can be combined in all possible combinations and sub-combinations to produce exemplary embodiments of the invention. The examples given above are exemplary in nature and are not intended to limit the scope of the invention which is defined solely by the following claims.

The terms “include”, “comprise” and “have” and their conjugates as used herein mean “including but not necessarily limited to”.

1. A digitizer comprising:
a digitizer sensor comprising at least one pair of conductive lines coupled to at least one differential amplifier through which a difference signal is detected; and
at least one capacitor operative to balance differences in parasitic capacitance between the conductive lines of the at least one pair of conductive lines.

2. The digitizer according to claim 1 wherein the at least one capacitor is coupled to at least one conductive line of the pair.

3. The digitizer according to claim 1 wherein a capacitor is coupled to each conductive line of the pair.

4. The digitizer according to claim 1 wherein a capacitor is coupled to at least one conductive line through a switch.

5. The digitizer according to claim 4 wherein the switch is a MOSFET switch.

6. The digitizer according to claim 1 wherein the at least one capacitor is a variable capacitor.

7. The digitizer according to claim 1 wherein the at least one capacitor has a capacitance level between 0-3.2 pF.

8. The digitizer according to claim 1 wherein the at least one capacitor includes a group of capacitors, each capacitor in the group associated with a switch.

9. The digitizer according to claim 1 wherein the at least one capacitor includes a group of capacitors connected in parallel, each capacitor in the group associated with a switch.

10. The digitizer according to claim 8 wherein capacitors in the group of capacitors have a capacitance value double that of one other capacitor in the group.

11. The digitizer according to claim 8 wherein the switch is a MOSFET switch.

12. The digitizer according to claim 1 comprising a fixed capacitor coupled to at least one conductive line of the pair.

13. The digitizer according to claim 1 wherein the at least one pair of conductive lines are parallel to each other.

14. The digitizer according to claim 1 wherein the at least one pair of conductive lines are distanced by at least the effective range of a user input signal.

15. The digitizer according to claim 1 comprising multiple pairs of conductive lines arranged in a matrix of vertical and horizontal conductive lines.

16. The digitizer according to claim 1 wherein an object placed over one of the conductive lines of the pair produces an output on a differential amplifier.

17. The digitizer according to claim 1 comprising circuitry operative to adjust the capacitance level of the at least one capacitor.

18. The digitizer according to claim 17 wherein the at least one capacitor has a capacitance operative to increase the common mode rejection ratio of the at least one differential amplifier.

19. The digitizer according to claim 1 comprising circuitry operative to detect and sample the difference signal.

20. The digitizer according to claim 1 comprising circuitry operative to filter the difference signal.

21. The digitizer according to claim 1 wherein the capacitor has a capacitance operative to decrease a steady-state noise in the difference signal.

22. The digitizer according to claim 1 comprising one or more ASICs wherein the one or more ASICs comprises:
the at least one capacitor;
the at least one differential amplifier.

23. The digitizer according to claim 22 wherein the ASIC is operative to adjust the capacitance level of the at least one capacitor.

24. The digitizer according to claim 22 wherein the ASIC is operative to receive capacitance level from a digital unit.

25. A method for reducing the effects of unbalanced parasitic capacitance in a digitizer comprising:
detecting a difference signal between a pair of conductive lines of a digitizer sensor; and
coupling a capacitor to at least one conductive line of the pair of conductive lines to reduce the imbalance.

26. The method according to claim 25 wherein the difference signal is detected while no object is placed over the digitizer sensor.

27. The method according to claim 25 wherein the difference signal is obtained from unbalanced capacitance on the pair of conductive lines.

28. The method according to claim 25 wherein the difference signal is obtained from unbalanced circuitry of the digitizer.

29. The method according to claim 25 wherein the capacitor is coupled to each conductive line of the pair.

30. The method according to claim 25 wherein the capacitor is coupled to the at least one conductive line through a switch.

31. The method according to claim 30 wherein the switch is a MOSFET switch.

32. The method according to claim 25 wherein the capacitor is a variable capacitor.

33. The method according to claim 25 wherein the capacitor has a capacitance level between 0-3.2 pF.

34. The method according to claim 25 wherein the capacitor includes a group of capacitors, each capacitor in the group associated with a switch.

35. The method according to claim 25 wherein the capacitor includes a group of capacitors connected in parallel, each capacitor in the group associated with a switch.

36. The method according to claim 34 wherein the switch is a MOSFET switch.

37. The method according to claim 34 comprising controlling the switch to obtain a desired capacitance level.

38. The method according to claim 25 comprising coupling a fixed capacitor to at least one conductive line of the pair.

39. The method according to claim 25 comprising inducing an AC signal onto the pair of conductive lines.

40. The method according to claim 25 comprising adjusting the capacitance level to a value that corresponds to difference signal below a defined threshold.

41. The method according to claim 25 comprising:
detecting the difference signals for a range of capacitance levels coupled on the at least one conductive line; and
selecting a capacitance level from the range of capacitance levels that yields a minimum difference signal.

42. The method according to claim 25 wherein the capacitor is integrated into an ASIC.

43. The method according to claim 42 wherein the ASIC is operative to adjust the capacitance level of the capacitor.

44. The method according to claim 25 wherein a differential amplifier is operative to detect the difference signal.

45. The method according to claim 44 wherein the capacitor has a capacitance operative to increase the common mode rejection ratio of the differential amplifier.

46. The method according to claim 25 comprising filtering and sampling the difference signal.

47. A method of operating a sensor comprising at least one array of conductive lines spaced apart in a given direction and a plurality of differential amplifiers to which said conductive lines are pairwise coupled, the method including:
adding a capacitance to at least one line of each pair operative to compensate for imbalance capacitance;
electrifying each line of a given pair with a same voltage; and
determining whether a touch occurs near a conductor from an output voltage of said amplifier.

48. The method according to claim 47 wherein the imbalanced is operative to balance differences in parasitic capacitance between the conductive lines of the pairs.

49. The method according to claim 47 wherein the capacitance are selected using the method according to claim 25.

50. The method according to claim 47 comprising a second array of conductive lines spaced apart in a given direction, the second array perpendicular to the given array.

51. The method according to claim 47 wherein the pairwise coupled conductive lines are parallel lines.

52. The method according to claim 47 wherein the pairwise coupled conductive lines are spaced apart at a distance greater than the width of a finger.

53. A digitizer comprising:
a digitizer sensor comprising at least one pair of conductive lines coupled to at least one differential amplifier through which a difference signal is detected; and
at least one capacitor operative to minimize the output signal of the differential amplifier when no object is present over the digitizer sensor.
